(19) United States
(12) Patent Application Publication
(10) Pub. No.: US 2017/0280270 A1
(43) Pub. Date: Sep. 28, 2017

(54) METHOD FOR CONTROLLING APPLICATION RELATED TO THIRD PARTY SERVER IN WIRELESS COMMUNICATION SYSTEM AND DEVICE FOR SAME

(71) Applicant: LG ELECTRONICS INC., Seoul (KR)

(72) Inventors: Laeyoung KIM, Seoul (KR); Jinsook RYU, Seoul (KR); Hyunsook KIM, Seoul (KR); Jaehyun KIM, Seoul (KR); Taehun KIM, Seoul (KR)

(73) Assignee: LG ELECTRONICS INC., Seoul (KR)

(21) Appl. No.: 15/507,142

(22) PCT Filed: Aug. 31, 2015
(86) PCT No.: PCT/KR2015/009150

§ 371 Date: Feb. 27, 2017

Related U.S. Application Data
(60) Provisional application No. 62/044,309, filed on Aug. 31, 2014.

(51) Int. Cl. H04W 4/00; H04L 29/08

(52) U.S. Cl. CPC H04W 4/001; H04L 67/34; H04W 12/08

(57) ABSTRACT

An embodiment of the present invention relates to a method for controlling an application related to a third party server by a network node in a wireless communication system. The application control method comprises the steps of: receiving a Control of Applications when Third Party Servers encounter difficulties (CATS)-related policy from a gateway; and transmitting the CATS-related policy to a terminal, wherein the network node stores the CATS-related policy when the terminal is in an idle mode.

### TECHNICAL FIELD

Following description relates to a wireless communication system, and more particularly, to a method of controlling an application related to a third party server and an apparatus therefor.

### BACKGROUND ART

Wireless access systems have been widely deployed to provide various types of communication services such as voice or data. In general, a wireless access system is a multiple access system that may support communication of multiple users by sharing available system resources (e.g., a bandwidth, transmission power, etc.). For example, multiple access systems include a Code Division Multiple Access (CDMA) system, a Frequency Division Multiple Access (FDMA) system, a Time Division Multiple Access (TDMA) system, an Orthogonal Frequency Division Multiple Access (OFDMA) system, a Single Carrier Frequency Division Multiple Access (SC-FDMA) system, and a multi carrier frequency division multiple access (MC-FDMA) system.

### DISCLOSURE OF THE INVENTION

Technical Task

A technical task of the present invention is to provide a method of controlling an application related to a third party server.

Technical tasks obtainable from the present invention are non-limited by the above-mentioned technical task. And, other unmentioned technical tasks can be clearly understood from the following description by those having ordinary skill in the technical field to which the present invention pertains.

Technical Solution

To achieve these and other advantages and in accordance with the purpose of the present invention, as embodied and broadly described, according to one embodiment, a method of controlling a third party server-related application, which is controlled by a network node in a wireless communication system, includes the steps of receiving a CATS (control of applications when third party servers encounter difficulties)-related policy from a gateway, and transmitting the CATS-related policy to a UE. In this case, the network node stores the CATS-related policy when the UE is in an idle mode.

To further achieve these and other advantages and in accordance with the purpose of the present invention, according to a different embodiment, a network node controlling a third party server-related application in a wireless communication system includes a transceiver and a processor, the processor configured to receive a CATS (control of applications when third party servers encounter difficulties)-related policy from a gateway, the processor configured to transmit the CATS-related policy to a UE. In this case, the network node stores the CATS-related policy when the UE is in an idle mode.

The CATS-related policy can be transmitted in a manner of being included in a NAS (non-access stratum) message.

If the CATS-related policy is stored, the network node can transmit the stored CATS-related policy after a TAU request message is received from the UE.

The NAS message may correspond to a TAU accept message.

If the CATS-related policy is stored, the network node can transmit the stored CATS-related policy after a service request message is received from the UE.

The NAS message may correspond to a DOWNLINK GENERIC NAS TRANSPORT message.

The CATS-related policy can be generated or updated when a failure occurs on the third party server.

The CATS-related policy can reduce or terminate transmission of traffic heading to the third party server.

The CATS can be generated or updated by a PCRF (policy charging resource function).

The CATS can be deleted when the PCRF recognizes restoration of the third party server.

The network node may correspond to an MME (mobility management entity).

Advantageous Effects

According to the present invention, it is able to efficiently control traffic to an application related to a third party server.

Effects obtainable from the present invention are non-limited by the above mentioned effect. And, other unmentioned effects can be clearly understood from the following description by those having ordinary skill in the technical field to which the present invention pertains.

### DESCRIPTION OF DRAWINGS

The accompanying drawings, which are included to provide a further understanding of the invention and are incorporated in and constitute a part of this specification, illustrate embodiments of the invention and together with the description serve to explain the principles of the invention.

FIG. 1 is a diagram for a schematic structure of an EPS (evolved packet system) including an EPC (evolved packet core);

FIG. 2 is a diagram for an example of architecture of a general E-UTRAN and EPC;

FIG. 3 is a diagram for an example of a structure of a wireless interface protocol in a control plane;

FIG. 4 is a diagram for an example of a structure of a wireless interface protocol in a user plane;

FIG. 5 is a flowchart for explaining a random access procedure;

FIG. 6 is a diagram for a connection procedure in radio resource control (RRC) layer;

FIGS. 7 and 8 are diagrams for explaining CATS (control of applications when third party servers encounter difficulties);

FIGS. 9 to 11 are diagrams for explaining embodiments of the present invention;

FIG. 12 is a diagram for an example of a configuration of a node device according to embodiments of the present invention.

### BEST MODE

### Mode For Invention

The embodiments below are combinations of components and features of the present invention in a prescribed form. Each component or feature may be considered as selective unless explicitly mentioned as otherwise. Each component or feature may be executed in a form that is not combined with other components and features. Further, some components and/or features may be combined to configure an embodiment of the present invention. The order of operations described in the embodiments of the present invention may be changed. Some components or features of an embodiment may be included in another embodiment or may be substituted with a corresponding component or feature of the present invention.

Specific terms used in the description below are provided to help an understanding of the present invention, and the use of such specific terms may be changed to another form within the scope of the technical concept of the present invention.

In some cases, in order to avoid obscurity of the concept of the present invention, a known structure and apparatus may be omitted, or a block diagram centering on core functions of each structure or apparatus may be used. Moreover, the same reference numerals are used for the same components throughout the present specification.

The embodiments of the present invention may be supported by standard documents disclosed with respect to at least one of IEEE (Institute of Electrical and Electronics Engineers) 802 group system, 3GPP system, 3GPP LTE & LTE-A system and 3GPP2 system. Namely, the steps or portions having not been described in order to clarify the technical concept of the present invention in the embodiments of the present invention may be supported by the above documents. Furthermore, all terms disclosed in the present document may be described according to the above standard documents.

The technology below may be used for various wireless communication systems. For clarity, the description below centers on 3GPP LTE and 3GPP LTE-A, by which the technical idea of the present invention is non-limited.

Terms used in the present document are defined as follows.

UMTS (Universal Mobile Telecommunications System): a GSM (Global System for Mobile Communication) based third generation mobile communication technology developed by the 3GPP.

EPS (Evolved Packet System): a network system that includes an EPC (Evolved Packet Core) which is an IP (Internet Protocol) based packet switched core network and an access network such as LTE and UTRAN. This system is the network of an evolved version of the UMTS.

NodeB: a base station of GERAN/UTRAN. This base station is installed outdoor and its coverage has a scale of a macro cell.

eNodeB: a base station of LTE. This base station is installed outdoor and its coverage has a scale of a macro cell.

UE (User Equipment): the UE may be referred to as terminal, ME (Mobile Equipment), MS (Mobile Station), etc. Also, the UE may be a portable device such as a notebook computer, a cellular phone, a PDA (Personal Digital Assistant), a smart phone, and a multimedia device. Alternatively, the UE may be a non-portable device such as a PC (Personal Computer) and a vehicle mounted device. The term “UE”, as used in relation to MTC, can refer to an MTC device.

HNB (Home NodeB): a base station of UMTS network. This base station is installed indoor and its coverage has a scale of a micro cell.

HeNB (Home eNodeB): a base station of an EPS network. This base station is installed indoor and its coverage has a scale of a micro cell.

MME (Mobility Management Entity): a network node of an EPS network, which performs mobility management (MM) and session management (SM).

PDN-GW (Packet Data Network-Gateway)/PGW: a network node of an EPS network, which performs UE IP address allocation, packet screening and filtering, charging data collection, etc.

SGW (Serving Gateway): a network node of an EPS network, which performs mobility anchor, packet routing, idle-mode packet buffering, and triggering of an MME's UE paging.

NAS (Non-Access Stratum): an upper stratum of a control plane between a UE and an MME. This is a functional layer for transmitting and receiving a signaling and traffic message between a UE and a core network in an LTE/UMTS protocol stack, and supports mobility of a UE, and supports a session management procedure of establishing and maintaining IP connection between a UE and a PDN GW.

PDN (Packet Data Network): a network in which a server supporting a specific service (e.g., a Multimedia Messaging Service (MMS) server, a Wireless Application Protocol (WAP) server, etc.) is located.

PDN connection: a logical connection between a UE and a PDN, represented as one IP address (one IPv4 address and/or one IPv6 prefix).

RAN (Radio Access Network): a unit including a Node B, an eNode B, and a Radio Network Controller (RNC) for controlling the Node B and the eNode B in a 3GPP network, which is present between UEs and provides a connection to a core network.

HLR (Home Location Register)/HSS (Home Subscriber Server): a database having subscriber information in a 3GPP network. The HSS can perform functions such as configuration storage, identity management, and user state storage.

PLMN (Public Land Mobile Network): a network configured for the purpose of providing mobile communication services to individuals. This network can be configured per operator.

Proximity Services (or ProSe Service or Proximity-based Service): a service that enables discovery between physically proximate devices, and mutual direct communication/communication through a base station/communication through the third party. At this time, user plane data are exchanged through a direct data path without through a 3GPP core network (for example, EPC).

ProSe Communication: communication between two or more ProSe-enabled UEs in proximity by means of a ProSe Communication path. Unless explicitly stated otherwise, the term “ProSe Communication” refers to any/all of the following: ProSe E-UTRA Communication, ProSe-assisted WLAN direct communication between two UEs, ProSe Group Communication and ProSe Broadcast Communication.

ProSe E-UTRA Communication: ProSe Communication using a ProSe E-UTRA Communication path.

ProSe-assisted WLAN direct communication: ProSe Communication using a ProSe-assisted WLAN direct communication path.

ProSe Communication path: communication path supporting ProSe Communication. The ProSe E-UTRA Communication path could be established between the ProSe-enabled UEs using E-UTRA, or routed via local eNB(s). The ProSe-assisted WLAN direct communication path may be established directly between the ProSe-enabled UEs using WLAN.

EPC Path (or infrastructure data path): the user plane communication path through EPC.

ProSe Discovery: a process that identifies that a UE that is ProSe-enabled is in proximity of another, using E-UTRA.

ProSe Group Communication: one-to-many ProSe Communication, between more than two ProSe-enabled UEs in proximity, by means of a common communication path established between the ProSe-enabled UEs.

ProSe UE-to-Network Relay: is a form of relay in which a ProSe-enabled Public Safety UE acts as a communication relay between a ProSe-enabled Public Safety UE and the ProSe-enabled network using E-UTRA.

ProSe UE-to-UE Relay: is a form of relay in which a ProSe-enabled Public Safety UE acts as a ProSe Communication relay between two or more ProSe-enabled Public Safety UEs.

Remote UE: This is a Prose-enabled public safety UE connected to EPC through Prose UE-to-Network Relay without service from E-UTRAN in a UE-to-Network Relay operation, that is, Prose-enabled public safety UE configured to receive PDN connection, whereas this is a Prose-enabled public safety UE that performs communication with other Prose-enabled public safety UE through a Prose UE-to-UE Relay in a UE-to-UE relay operation.

ProSe-enabled Network: a network that supports ProSe Discovery, ProSe Communication and/or ProSe-assisted WLAN direct communication. Hereinafter, the ProSe-enabled Network may simply be referred to as a network.

ProSe-enabled UE: a UE that supports ProSe Discovery, ProSe Communication and/or ProSe-assisted WLAN direct communication. Hereinafter, the ProSe-enabled UE and the ProSe-enabled Public Safety UE may be referred to as UE.

Proximity: proximity is determined (“a UE is in proximity of another UE”) when given proximity criteria are fulfilled. Proximity criteria can be different for discovery and communication.

SLP(SUPL Location Platform): entity that controls Location Service Management and Position Determination. The SLP includes SLC(SUPL Location Center) function and SPC(SUPL Positioning Center) function. Details of the SLP will be understood with reference to Open Mobile Alliance(OMA) standard document OMA AD SUPL: “Secure User Plane Location Architecture”.

USD(User Service Description): application/service layer transmits USD, which includes TMGI(Temporary Mobile Group Identity) for each MBMS service, start and end time of session, frequencies, and MBMS service area identities(MBMS SAIs) information belonging to MBMS service area, to the UE. Details of the USD will be understood with reference to 3GPP TS 23.246.

ISR (Idle mode Signaling Reduction): When a UE frequently moves between E-UTRAN and UTRAN/GERAN, waste of network resources occurs due to a repeated position registration process. As a method for reducing such a waste, when the UE is in an idle mode, after position registration for MME and SGSN (hereinafter, these two nodes will be referred to as mobility management node) is performed through the E-UTRAN and the UTRAN/GERAN, a separate position registration is not performed in the case that movement between two RATs (Radio Access Technologies) which are already registered or cell reselection is performed. Therefore, if DL (downlink) data to the corresponding UE is arrived, paging is transmitted to the E-UTRAN and the UTRAN/GERAN at the same time to successfully discover the UE, whereby the DL data may be transferred to the discovered UE. [see 3GPP TS 23.401 and 3GPP TS 23.060]

Evolved Packet Core (EPC)

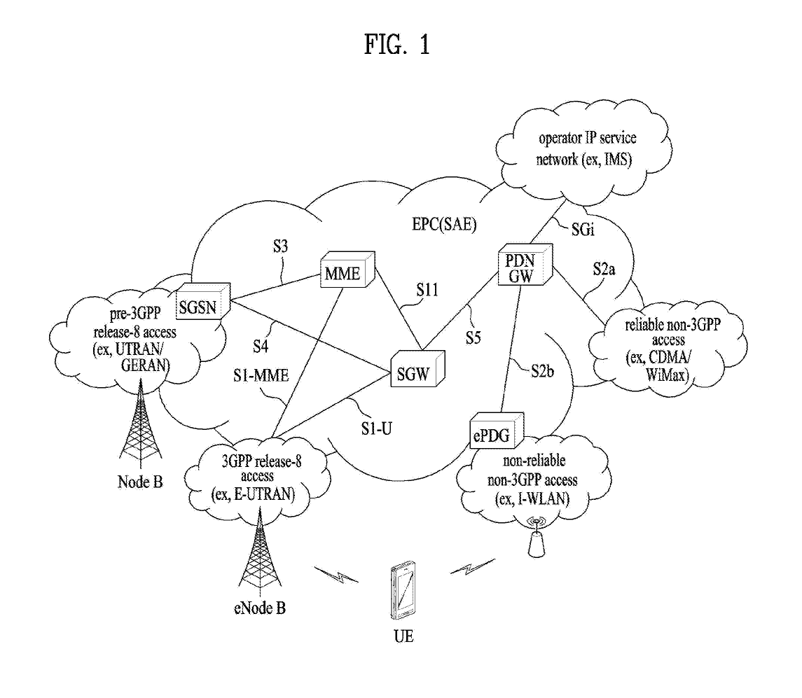

FIG. 1 is a schematic diagram showing the structure of an evolved packet system (EPS) including an evolved packet core (EPC).

The EPC is a core element of system architecture evolution (SAE) for improving performance of 3GPP technology. SAE corresponds to a research project for determining a network structure supporting mobility between various types of networks. For example, SAE aims to provide an optimized packet-based system for supporting various radio access technologies and providing an enhanced data transmission capability.

Specifically, the EPC is a core network of an IP mobile communication system for 3GPP LTE and can support real-time and non-real-time packet-based services. In conventional mobile communication systems (i.e. second-generation or third-generation mobile communication systems), functions of a core network are implemented through a circuit-switched (CS) sub-domain for voice and a packet-switched (PS) sub-domain for data. However, in a 3GPP LTE system which is evolved from the third generation communication system, CS and PS sub-domains are unified into one IP domain. That is, In 3GPP LTE, connection of terminals having IP capability can be established through an IP-based business station (e.g., an eNodeB (evolved Node B)), EPC, and an application domain (e.g., IMS). That is, the EPC is an essential structure for end-to-end IP services.

The EPC may include various components. FIG. 1 shows some of the components, namely, a serving gateway (SGW), a packet data network gateway (PDN GW), a mobility management entity (MME), a serving GPRS (general packet radio service) supporting node (SGSN) and an enhanced packet data gateway (ePDG).

The SGW operates as a boundary point between a radio access network (RAN) and a core network and maintains a data path between an eNodeB and the PDN GW. When. When a terminal moves over an area served by an eNodeB, the SGW functions as a local mobility anchor point. That is, packets. That is, packets may be routed through the SGW for mobility in an evolved UMTS terrestrial radio access network (E-UTRAN) defined after 3GPP release-8. In addition, the SGW may serve as an anchor point for mobility of another 3GPP network (a RAN defined before 3GPP release-8, e.g., UTRAN or GERAN (global system for mobile communication (GSM)/enhanced data rates for global evolution (EDGE) radio access network).

The PDN GW corresponds to a termination point of a data interface for a packet data network. The PDN GW may support policy enforcement features, packet filtering and charging support. In addition, the PDN GW may serve as an anchor point for mobility management with a 3GPP network and a non-3GPP network (e.g., an unreliable network such as an interworking wireless local area network (I-WLAN) and a reliable network such as a code division multiple access (CDMA) or WiMax network).

Although the SGW and the PDN GW are configured as separate gateways in the example of the network structure of FIG. 1, the two gateways may be implemented according to a single gateway configuration option.

The MME performs signaling and control functions for supporting access of a UE for network connection, network resource allocation, tracking, paging, roaming and handover. The MME controls control plane functions associated with subscriber and session management. The MME manages numerous eNodeBs and signaling for selection of a conventional gateway for handover to other 2G/3G networks. In addition, the MME performs security procedures, terminal-to-network session handling, idle terminal location management, etc.

The SGSN handles all packet data such as mobility management and authentication of a user for other 3GPP networks (e.g., a GPRS network).

The ePDG serves as a security node for a non-3GPP network (e.g., an I-WLAN, a Wi-Fi hotspot, etc.).

As described above with reference to FIG. 1, a terminal having IP capabilities may access an IP service network (e.g., an IMS) provided by an operator via various elements in the EPC not only based on 3GPP access but also on non-3GPP access.

Additionally, FIG. 1 shows various reference points (e.g. S1-U, S1-MME, etc.). In 3GPP, a conceptual link connecting two functions of different functional entities of an E-UTRAN and an EPC is defined as a reference point. Table 1 is a list of the reference points shown in FIG. 1. Various reference points may be present in addition to the reference points in Table 1 according to network structures.

TABLE 1

| Reference | |
|---|---|
| point | Description |
| S1-MME | Reference point for the control plane protocol between E-UTRAN and MME |
| S1-U | Reference point between E-UTRAN and Serving GW for the per bearer user plane |
| | tunneling and inter eNodeB path switching during handover |
| S3 | It enables user and bearer information exchange for inter 3GPP access network |
| | mobility in idle and/or active state. This reference point can be used intra-PLMN or |
| | inter-PLMN (e.g. in the case of Inter-PLMN HO). |
| S4 | It provides related control and mobility support between GPRS Core and the 3GPP |
| | Anchor function of Serving GW. In addition, if Direct Tunnel is not established, it |
| | provides the user plane tunneling. |
| S5 | It provides user plane tunneling and tunnel management between Serving GW and |
| | PDN GW. It is used for Serving GW relocation due to UE mobility and if the |
| | Serving GW needs to connect to a non-collocated PDN GW for the required PDN |
| | connectivity. |
| S11 | Reference point between an MME and an SGW |
| SGi | It is the reference point between the PDN GW and the packet data network. Packet |
| | data network may be an operator external public or private packet data network or |
| | an intra operator packet data network, e.g. for provision of IMS services. This |
| | reference point corresponds to Gi for 3GPP accesses. |

Among the reference points shown in FIG. 1, S2a and S2b correspond to non-3GPP interfaces. S2a is a reference point which provides reliable non-3GPP access and related control and mobility support between PDN GWs to a user plane. S2b is a reference point which provides related control and mobility support between the ePDG and the PDN GW to the user plane.

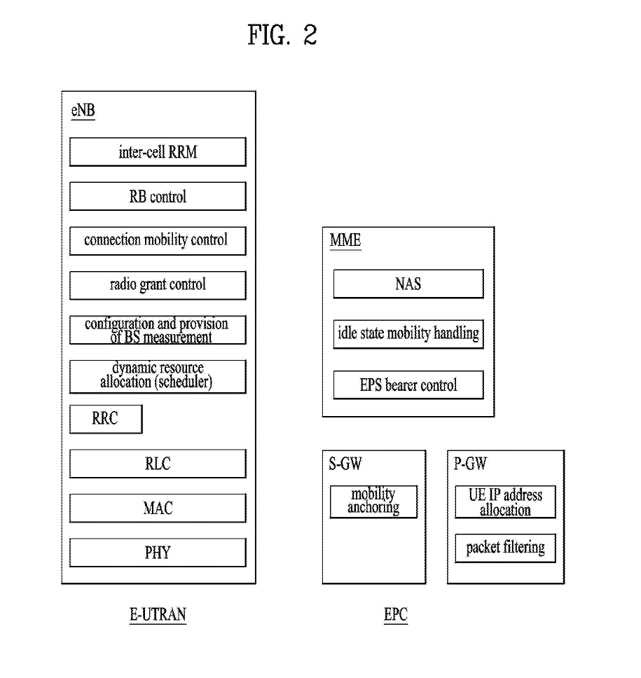

FIG. 2 is a diagram exemplarily illustrating architectures of a typical E-UTRAN and EPC.

As shown in the figure, while radio resource control (RRC) connection is activated, an eNodeB may perform routing to a gateway, scheduling transmission of a paging message, scheduling and transmission of a broadcast channel (BCH), dynamic allocation of resources to a UE on uplink and downlink, configuration and provision of eNodeB measurement, radio bearer control, radio admission control, and connection mobility control. In the EPC, paging generation, LTE_IDLE state management, ciphering of the user plane, SAE bearer control, and ciphering and integrity protection of NAS signaling.

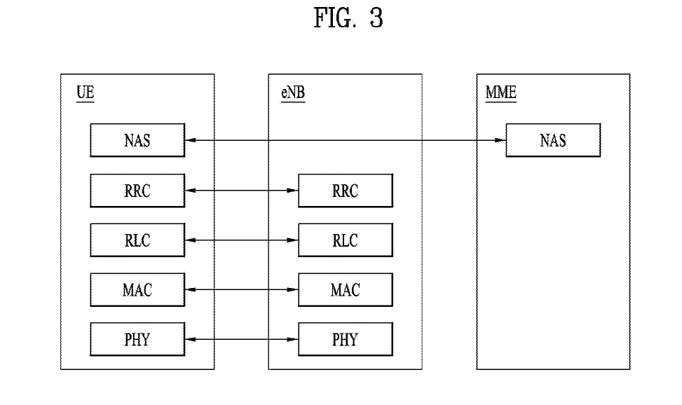

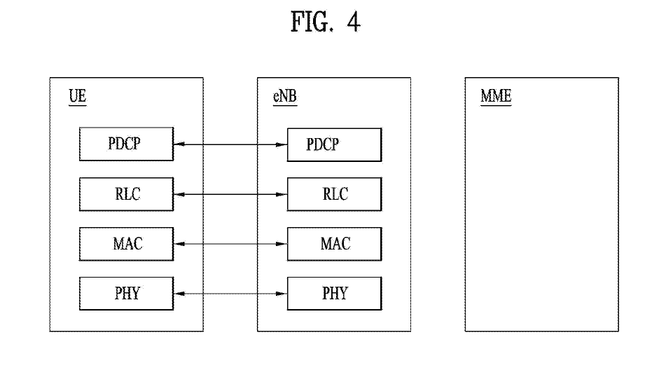

FIG. 3 is a diagram exemplarily illustrating the structure of a radio interface protocol in a control plane between a UE and a base station, and FIG. 4 is a diagram exemplarily illustrating the structure of a radio interface protocol in a user plane between the UE and the base station.

The radio interface protocol is based on the 3GPP wireless access network standard. The radio interface protocol horizontally includes a physical layer, a data link layer, and a networking layer. The radio interface protocol is divided into a user plane for transmission of data information and a control plane for delivering control signaling which are arranged vertically.

The protocol layers may be classified into a first layer (L1), a second layer (L2), and a third layer (L3) based on the three sublayers of the open system interconnection (OSI) model that is well known in the communication system.

Hereinafter, description will be given of a radio protocol in the control plane shown in FIG. 3 and a radio protocol in the user plane shown in FIG. 4.

The physical layer, which is the first layer, provides an information transfer service using a physical channel The physical channel layer is connected to a medium access control (MAC) layer, which is a higher layer of the physical layer, through a transport channel Data is transferred between the physical layer and the MAC layer through the transport channel Transfer of data between different physical layers, i.e., a physical layer of a transmitter and a physical layer of a receiver is performed through the physical channel.

The physical channel consists of a plurality of subframes in the time domain and a plurality of subcarriers in the frequency domain. One subframe consists of a plurality of symbols in the time domain and a plurality of subcarriers. One subframe consists of a plurality of resource blocks. One resource block consists of a plurality of symbols and a plurality of subcarriers. A Transmission Time Interval (TTI), a unit time for data transmission, is 1 ms, which corresponds to one subframe.

According to 3GPP LTE, the physical channels present in the physical layers of the transmitter and the receiver may be divided into data channels corresponding to Physical Downlink Shared Channel (PDSCH) and Physical Uplink Shared Channel (PUSCH) and control channels corresponding to Physical Downlink Control Channel (PDCCH), Physical Control Format Indicator Channel (PCFICH), Physical Hybrid-ARQ Indicator Channel (PHICH) and Physical Uplink Control Channel (PUCCH).

The second layer includes various layers.

First, the MAC layer in the second layer serves to map various logical channels to various transport channels and also serves to map various logical channels to one transport channel The MAC layer is connected with an RLC layer, which is a higher layer, through a logical channel. The logical channel is broadly divided into a control channel for transmission of information of the control plane and a traffic channel for transmission of information of the user plane according to the types of transmitted information.

The radio link control (RLC) layer in the second layer serves to segment and concatenate data received from a higher layer to adjust the size of data such that the size is suitable for a lower layer to transmit the data in a radio interval.

The Packet Data Convergence Protocol (PDCP) layer in the second layer performs a header compression function of reducing the size of an IP packet header which has a relatively large size and contains unnecessary control information, in order to efficiently transmit an IP packet such as an IPv4 or IPv6 packet in a radio interval having a narrow bandwidth. In addition, in LTE, the PDCP layer also performs a security function, which consists of ciphering for preventing a third party from monitoring data and integrity protection for preventing data manipulation by a third party.

The Radio Resource Control (RRC) layer, which is located at the uppermost part of the third layer, is defined only in the control plane, and serves to configure radio bearers (RBs) and control a logical channel, a transport channel, and a physical channel in relation to reconfiguration and release operations. The RB represents a service provided by the second layer to ensure data transfer between a UE and the E-UTRAN.

If an RRC connection is established between the RRC layer of the UE and the RRC layer of a wireless network, the UE is in the RRC Connected mode. Otherwise, the UE is in the RRC Idle mode.

Hereinafter, description will be given of the RRC state of the UE and an RRC connection method. The RRC state refers to a state in which the RRC of the UE is or is not logically connected with the RRC of the E-UTRAN. The RRC state of the UE having logical connection with the RRC of the E-UTRAN is referred to as an RRC_CONNECTED state. The RRC state of the UE which does not have logical connection with the RRC of the E-UTRAN is referred to as an RRC_IDLE state. A UE in the RRC_CONNECTED state has RRC connection, and thus the E-UTRAN may recognize presence of the UE in a cell unit. Accordingly, the UE may be efficiently controlled. On the other hand, the E-UTRAN cannot recognize presence of a UE which is in the RRC_IDLE state. The UE in the RRC_IDLE state is managed by a core network in a tracking area (TA) which is an area unit larger than the cell. That is, for the UE in the RRC_IDLE state, only presence or absence of the UE is recognized in an area unit larger than the cell. In order for the UE in the RRC_IDLE state to be provided with a usual mobile communication service such as a voice service and a data service, the UE should transition to the RRC_CONNECTED state. A TA is distinguished from another TA by a tracking area identity (TAI) thereof. A UE may configure the TAI through a tracking area code (TAC), which is information broadcast from a cell.

When the user initially turns on the UE, the UE searches for a proper cell first. Then, the UE establishes RRC connection in the cell and registers information thereabout in the core network. Thereafter, the UE stays in the RRC_IDLE state. When necessary, the UE staying in the RRC_IDLE state selects a cell (again) and checks system information or paging information. This operation is called camping on a cell. Only when the UE staying in the RRC_IDLE state needs to establish RRC connection, does the UE establish RRC connection with the RRC layer of the E-UTRAN through the RRC connection procedure and transition to the RRC_CONNECTED state. The UE staying in the RRC_IDLE state needs to establish RRC connection in many cases. For example, the cases may include an attempt of a user to make a phone call, an attempt to transmit data, or transmission of a response message after reception of a paging message from the E-UTRAN.

The non-access stratum (NAS) layer positioned over the RRC layer performs functions such as session management and mobility management.

Hereinafter, the NAS layer shown in FIG. 3 will be described in detail.

The eSM (evolved Session Management) belonging to the NAS layer performs functions such as default bearer management and dedicated bearer management to control a UE to use a PS service from a network. The UE is assigned a default bearer resource by a specific packet data network (PDN) when the UE initially accesses the PDN. In this case, the network allocates an available IP to the UE to allow the UE to use a data service. The network also allocates QoS of a default bearer to the UE. LTE supports two kinds of bearers. One bearer is a bearer having characteristics of guaranteed bit rate (GBR) QoS for guaranteeing a specific bandwidth for transmission and reception of data, and the other bearer is a non-GBR bearer which has characteristics of best effort QoS without guaranteeing a bandwidth. The default bearer is assigned to a non-GBR bearer. The dedicated bearer may be assigned a bearer having QoS characteristics of GBR or non-GBR.

A bearer allocated to the UE by the network is referred to as an evolved packet service (EPS) bearer. When the EPS bearer is allocated to the UE, the network assigns one ID. This ID is called an EPS bearer ID. One EPS bearer has QoS characteristics of a maximum bit rate (MBR) and/or a guaranteed bit rate (GBR).

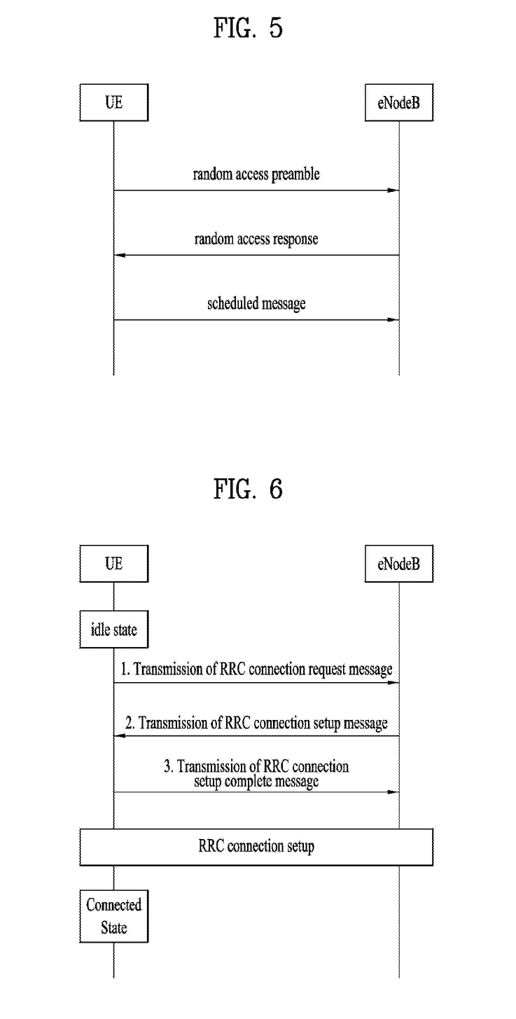

FIG. 5 is a flowchart illustrating a random access procedure in 3GPP LTE.

The random access procedure is used for a UE to obtain UL synchronization with an eNB or to be assigned a UL radio resource.

The UE receives a root index and a physical random access channel (PRACH) configuration index from an eNodeB. Each cell has 64 candidate random access preambles defined by a Zadoff-Chu (ZC) sequence. The root index is a logical index used for the UE to generate 64 candidate random access preambles.

Transmission of a random access preamble is limited to a specific time and frequency resources for each cell. The PRACH configuration index indicates a specific subframe and preamble format in which transmission of the random access preamble is possible.

The UE transmits a randomly selected random access preamble to the eNodeB. The UE selects a random access preamble from among 64 candidate random access preambles and the UE selects a subframe corresponding to the PRACH configuration index. The UE transmits the selected random access preamble in the selected subframe.

Upon receiving the random access preamble, the eNodeB sends a random access response (RAR) to the UE. The RAR is detected in two steps. First, the UE detects a PDCCH masked with a random access (RA)-RNTI. The UE receives an RAR in a MAC (medium access control) PDU (protocol data unit) on a PDSCH indicated by the detected PDCCH.

FIG. 6 illustrates a connection procedure in a radio resource control (RRC) layer.

As shown in FIG. 6, the RRC state is set according to whether or not RRC connection is established. An RRC state indicates whether or not an entity of the RRC layer of a UE has logical connection with an entity of the RRC layer of an eNodeB. An RRC state in which the entity of the RRC layer of the UE is logically connected with the entity of the RRC layer of the eNodeB is called an RRC connected state. An RRC state in which the entity of the RRC layer of the UE is not logically connected with the entity of the RRC layer of the eNodeB is called an RRC idle state.

A UE in the Connected state has RRC connection, and thus the E-UTRAN may recognize presence of the UE in a cell unit. Accordingly, the UE may be efficiently controlled. On the other hand, the E-UTRAN cannot recognize presence of a UE which is in the idle state. The UE in the idle state is managed by the core network in a tracking area unit which is an area unit larger than the cell. The tracking area is a unit of a set of cells. That is, for the UE which is in the idle state, only presence or absence of the UE is recognized in a larger area unit. In order for the UE in the idle state to be provided with a usual mobile communication service such as a voice service and a data service, the UE should transition to the connected state.

When the user initially turns on the UE, the UE searches for a proper cell first, and then stays in the idle state. Only when the UE staying in the idle state needs to establish RRC connection, the UE establishes RRC connection with the RRC layer of the eNodeB through the RRC connection procedure and then performs transition to the RRC connected state.

The UE staying in the idle state needs to establish RRC connection in many cases. For example, the cases may include an attempt of a user to make a phone call, an attempt to transmit data, or transmission of a response message after reception of a paging message from the E-UTRAN.

In order for the UE in the idle state to establish RRC connection with the eNodeB, the RRC connection procedure needs to be performed as described above. The RRC connection procedure is broadly divided into transmission of an RRC connection request message from the UE to the eNodeB, transmission of an RRC connection setup message from the eNodeB to the UE, and transmission of an RRC connection setup complete message from the UE to eNodeB, which are described in detail below with reference to FIG. 6.

1) When the UE in the idle state desires to establish RRC connection for reasons such as an attempt to make a call, a data transmission attempt, or a response of the eNodeB to paging, the UE transmits an RRC connection request message to the eNodeB first.

2) Upon receiving the RRC connection request message from the UE, the ENB accepts the RRC connection request of the UE when the radio resources are sufficient, and then transmits an RRC connection setup message, which is a response message, to the UE.

3) Upon receiving the RRC connection setup message, the UE transmits an RRC connection setup complete message to the eNodeB. Only when the UE successfully transmits the RRC connection setup message, does the UE establish RRC connection with the eNode B and transition to the RRC connected mode.

CATS (Control of Applications when Third Party Servers Encounter Difficulties)

If congestion or failure occurs in a third party server, it is necessary to control communication performed by an application of a UE utilizing the server to avoid the excessive use of a 3GPP network resource and not influence on a normally operating relevant server and a different application.

It is necessary for a 3GPP network to receive or detect indication indicating a congestion state and a failure state of the third party server from the third party server. Although HTTP and other third party protocols may have a status code, since the status code is unable to provide an appropriate indication for an application program in a UE, the status code is not sufficient for indicating the state of the third party server. As a result, retry can be frequently performed due to failure and it may become a burden on a network.

The congestion or the failure of the third party server can be classified into a soft failure and a hard failure. The soft failure corresponds to a case that the third party server is able to continuously provide a basic function although an application related to the third party server is in a difficult situation. In case of the soft failure, the third party server informs a 3GPP network that a third party server application program is congested or an error occurs. If it is necessary to take a step on a volume of traffic for an influenced third party application, the 3GPP network may take action of decreasing or terminating the traffic. Meanwhile, the hard failure corresponds to a case that the third party sever is unable to perform even a basic function. The third party server may be difficult to respond in response to incoming traffic or may be unable to indicate that there is a problem. In case of the hard failure, it may be able to perform a procedure of terminating the traffic rather than a procedure of decreasing the traffic.

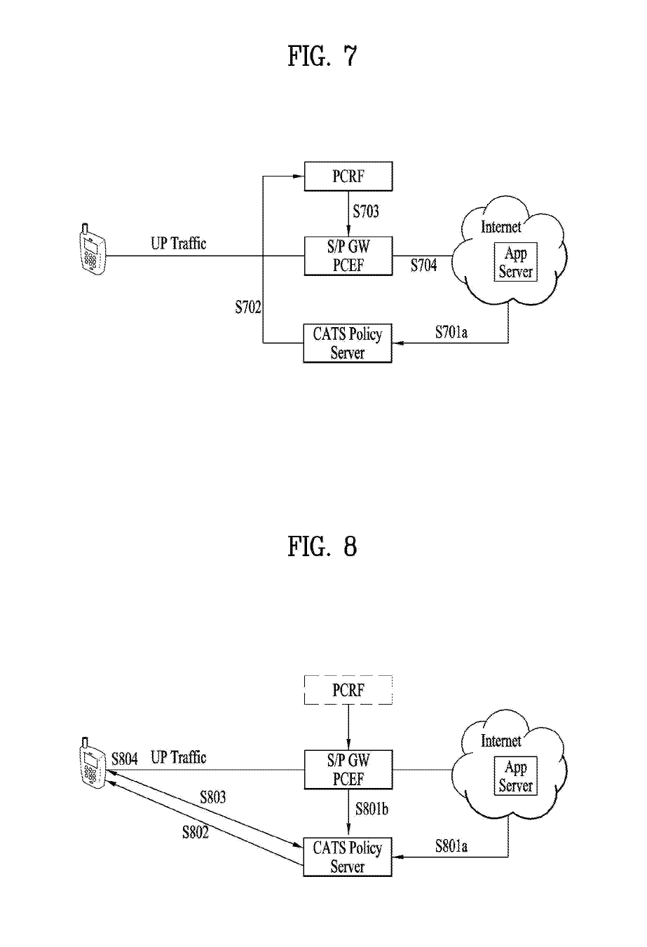

In case of the soft and hard failures, it may use a network-centered solution or a UE-centered solution. FIG. 7 illustrates an example of the network-centered solution. Referring to FIG. 7, in the step S701a, an application server asks a CATS policy server for help to reduce incoming traffic. In the step S701b, a P-GW determines that the application server does not respond and reports it to the CATS policy server. The steps S701a and S701b may correspond to a selective trigger option. In the step S702, the CATS PS asks a PCRF to perform a policy update for an uplink (UL) flow from a UE to the application server. In the step S703, the PCRF can update a policy in a PCEF. In the step S704, if the UE drives an application, an initial packet is generated and the packet is received by the P-GW. The PCEF suppresses the UL flow. If the initial packet transmitted to the application server is terminated, TCP is collapsed.

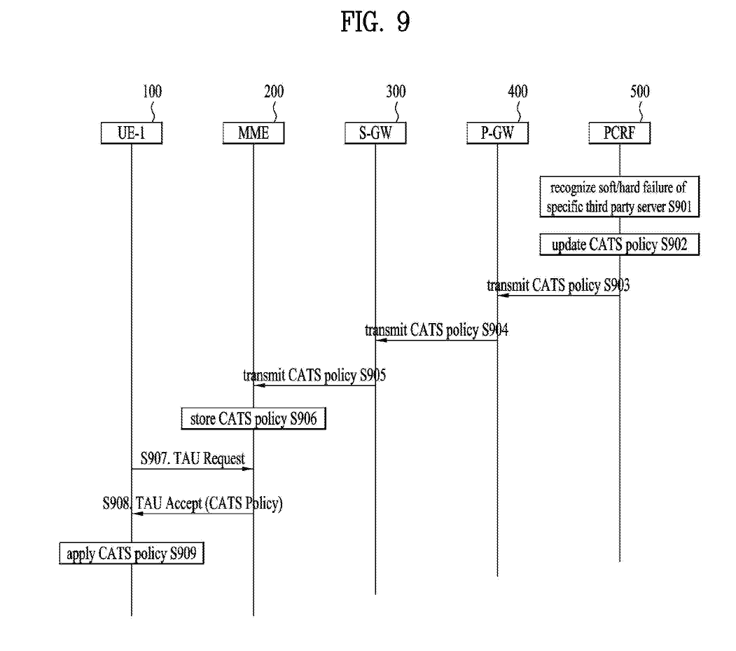

FIG. 8 illustrates an example of the UE-centered solution. Referring to FIG. 8, as a selective trigger option, an application server asks a CATS policy server for help to reduce incoming traffic [S801a]. A P-GW determines that the application server does not respond and reports it to the CATS PS [S801b]. In the step S802, the CATS PS forwards a policy update notification to a UE. For example, the CATS PS may start broadcasting to trigger policy update to all UEs. As shown in the step S803, a policy can be fetched by the UE as well. The policy may correspond to a list of destination addresses to be suppressed, expiration data, and/or a relevant parameter (e.g., level of suppression, etc.). In the step S804, a policy can be performed in the UE. The UE monitors outgoing traffic and suppresses traffic to an indicated destination address.

According to the aforementioned related art, in case of the network-centered solution, it is unable to completely reduce or eliminate traffic heading to an application server in a failure or congested state (unproductive radio access traffic or unproductive core network traffic). In this case, the UE-centered solution is more effective. Yet, in case of the UE-centered solution, it is necessary to transmit CATS-related policy to the UE. Specifically, as mentioned in the foregoing description, although it is able to use such a method as SIB, eMBMS, HTTP push, and the like, all of the methods are not efficient. This is because the method using the SIB or the eMBMS has overhead of fetching a policy fetched not only by a UE using an application to which CATS policy is (to be) applied but also by all UEs. And, in case of the method using the HTTP push, since the method requires communication between a server (network node) receiving a policy from a UE and a client/server to update a policy, it may cause a considerable amount of radio interface traffic.

Hence, when a third party system is in a situation such as a failure or congestion, a UE-centered solution mechanism capable of efficiently controlling an application of a UE performing communication with the third party system, a method of controlling an application of a network node, and the like are described in the embodiments of the present invention.

According to the embodiment of the present invention, an MME corresponding to a network node receives a CATS-related policy from a gateway and transmits the CATS-related policy to a UE. In this case, the transmission of the CATS-related policy may vary depending on whether the UE receiving the CATS-related policy is in an idle mode (idle state/ECM_IDLE) or a connected mode (connected state/ECM_connected). In particular, if the UE is in the idle mode, the MME can store the CATS-related policy. If the UE is in the connected mode, the MME can transmit the CATS-related policy without storing the CATS-related policy. According to the related art, the MME performs an operation of forwarding a message (including a policy, etc.) received from a gateway as it is. On the contrary, the MME according to the embodiment of the present invention stores the CATS-related policy according to a state of the UE. This is an operation according to a relation between specificity of the CATS-related policy and a state of the UE. More specifically, the CATS-related policy can be used for controlling traffic heading to a third party server (e.g., control information for not transmitting traffic to the third party server). Hence, if the UE has no chance to transmit uplink traffic (e.g., if the UE has no uplink traffic to be transmitted or is unable to transmit uplink traffic), it is not necessary to immediately transmit the CATS-related policy. In other word, if the UE is in the idle mode, since the UE does not transmit uplink traffic, the MME stores the CATS-related policy instead of immediately transmitting the CATS-related policy to the UE in the idle mode using not only a wired resource between network nodes but also a wireless resource via various procedures such as paging and the like.

The MME can store information on the CATS-related policy until the UE is switched to the connected state. If the UE is in the connected state, the MME can transmit the information to the UE. However, if the UE is in the connected state as a result of performing a TAU operation (i.e., a case of performing the TAU operation only without transmitting data/traffic, a case of performing the TAU operation to which an active flag is not set), the MME may not transmit the stored CATS-related policy information. This is because, since the CATS-related policy corresponds to a policy related to data/traffic transmission, if the UE does not perform data/traffic transmission, it is not necessary to provide the information on the CATS-related policy to the UE. And, when the UE is in the connected state, if the UE is in the connected state by a network triggered service request procedure, the MME may not transmit the stored CATS-related policy information. This is because, since the CATS is performed to control data/traffic heading to the third party system experiencing a failure or congestion, it is necessary to control MO (mobile oriented) data/traffic rather than MT (mobile terminated) data/traffic. Hence, if the UE does not transmit MO data/traffic, it is not necessary to provide the CATS-related policy to the UE.

Subsequently, the CATS-related policy can be transmitted in a manner of being included in an NAS message. In this case, the NAS message may correspond to a message previously defined in LTE/LTE-A or a newly defined message. Specifically, the NAS message in which the CATS-related policy is included may correspond to a TAU message. In this case, the MMU can transmit the stored CATS-related policy after a TAU request message is received from the UE. The MME can transmit the stored CATS-related policy after a service request message is received from the UE. In this case, the NAS message may correspond to a DOWNLINK GENERIC NAS TRANSPORT message.

The CATS-related policy is generated or updated when a failure occurs in the third party server. The CATS-related policy may put a ban on transmitting traffic to the third party server. The CATS-related policy is explained in more detail later. The CATS-related policy can be generated or updated by a PCRF. In this case, the CATS-related policy can be deleted when the PCRF recognizes restoration of the third party server. A CATS policy server may have a form co-located with the PCRF using a logical function.

In the following, embodiments shown in FIGS. 9 to 11 are explained.

Referring to FIG. 9, a PCRF detects/recognizes a soft failure or a hard failure of a specific third party server in the step S901. The soft failure or the hard failure can be detected by the PCRF, can be informed by a different network node, or can be notified by the third party server. In the step S902, the PCRF updates/generates a CATS-related policy to control (reduce/stop) traffic to the third party server. In the step S903, the PCRF transmits the CATS-related policy to a P-GW and the P-GW transmits the CATS-related policy to an S-GW [S904]. To this end, it may use a legacy GTP-C message (e.g., update bearer request) or a newly defined message. In the step S905, the S-GW transmits the CATS-related policy to an MME. To this end, it may use a legacy GTP-C message (e.g., update bearer request) or a newly defined message.

In the step S906, since the UE is in an idle mode, the MME stores the CATS-related policy instead of transmitting the CATS-related policy to the UE. In the step S907, the UE transmits a TAU request message to the MME at certain timing to perform a tracking area update operation. In the step S908, the MME transmits the stored CATS-related policy to the UE in a manner of including the CATS-related policy in a TAU accept message. The MME can transmit the CATS-related policy to the UE in a manner of including the CATS-related policy in a NAS message instead of the TAU accept message. In this case, the NAS message may correspond to a legacy NAS message (e.g., DOWNLINK GENERIC NAS TRANSPORT) or a newly defined NAS message. In the step S909, the UE applies the received CATS-related policy.

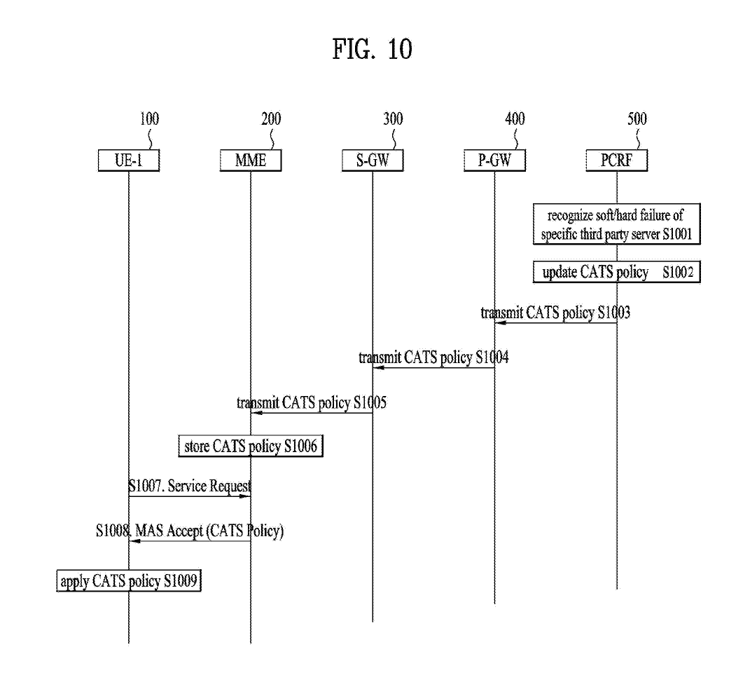

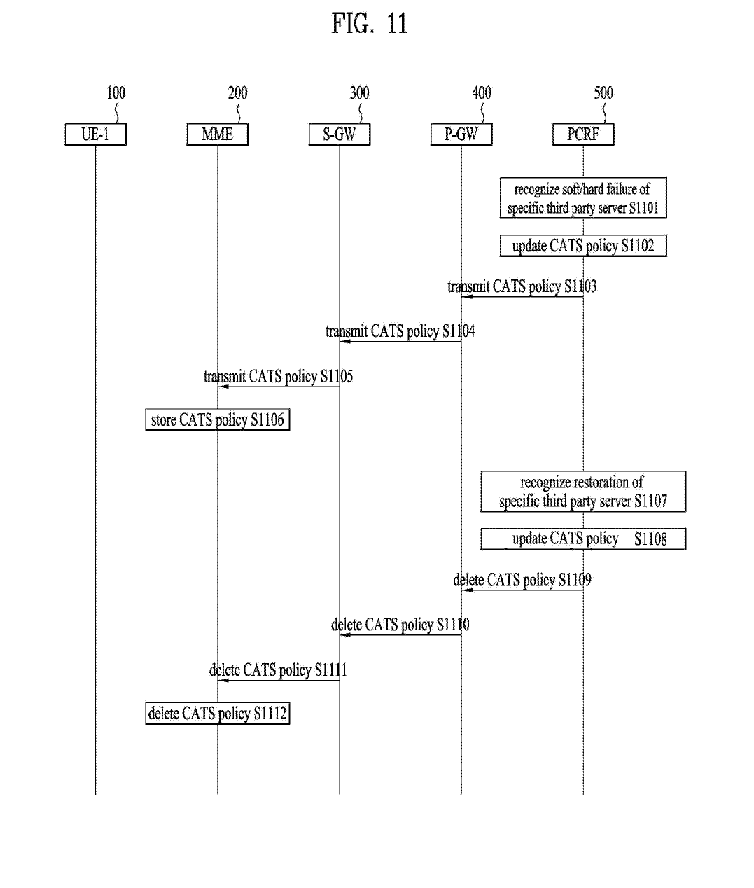

FIG. 10 shows an embodiment that an MME stores a CATS-related policy when a UE is in an idle mode. If the MME receives a service request from the UE [S1007], the MME transmits the CATS-related policy to the UE [S1008]. Since explanation on each of the steps (S1001 to S1006) is duplicated with the explanation on the steps S901 to S906 of FIG. 9, the explanation is omitted at this time.

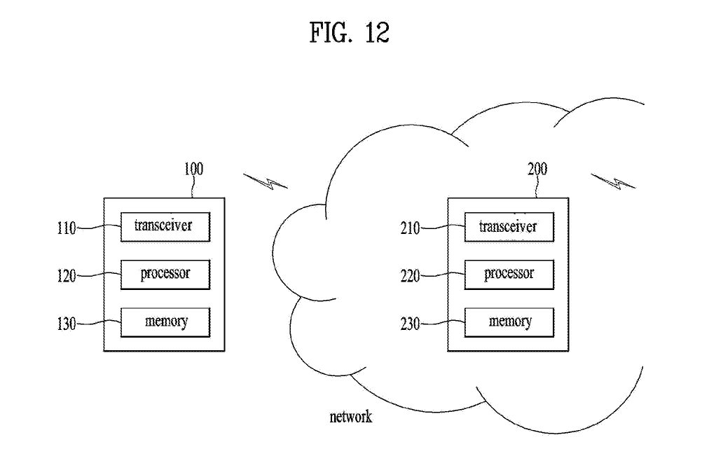

FIG. 11 shows a procedure of restoring a third party server from a failure and the like. Explanation on the steps S1101 to S1106 is replaced with the explanation on the steps S901 to S906. In the step S1107, the third party server is restored from a soft failure or a hard failure at certain timing. A PCRF detects/recognizes the restoration of the third party server. The restoration of the third party server can be detected by the PCRF, can be informed by a different network node, or can be notified by the third party server. In the step S1108, the PCRF updates/deletes the CATS-related policy to release the control of the traffic heading to the third party server. In the step S1109, the PCRF informs a P-GW that the CATS-related policy is updated/deleted. In the step S1110, the P-GW transmits a message to an S-GW to indicate that the CATS-related policy is updated/deleted. To this end, it may use a legacy GTP-C message (e.g., update bearer request) or a newly defined message. In the step S1111, the S-GW transmits a message to an MME to indicate that the CATS-related policy is updated/deleted. To this end, it may use a legacy GTP-C message (e.g., update bearer request) or a newly defined message. In the step S1112, the MME deletes/discards the stored CATS-related policy. In particular, while the UE in an idle mode, the CATS-related policy received by the MME and a deletion request of the policy received after the CATS-related policy are not transmitted to the UE. The CATS-related policy and the deletion request are internally stored in the MME and deleted. In FIGS. 9 to 11, although it is assumed that the CATS-related policy is forwarded on 3GPP network, the CATS-related policy can also be forwarded through WLAN. In this case, information on the policy can be forwarded in such a form as PCRF->P-GW->TWAN (trusted WLAN access network)->UE or PCRF->P-GW->ePDG->UE.

In the foregoing description, although the PCRF is described as a main entity for generating and/or updating the CATS-related policy, by which the embodiment of the present invention may be non-limited. In particular, the CATS-related policy can also be generated and/or updated by a CATS policy server, a gateway, and the like. The CATS-related policy can be generated or updated by the CATS policy server. In this case, if there exists an interface between the CATS policy server and the P-GW (i.e., if the CATS policy server is connected with the P-GW), the policy information can be forwarded in such a form as CATS policy server->P-GW->S-GW->MME->UE. Of course, when the policy information is forwarded to the UE from the MME, although the information is went through an eNode B, it may be able to express as the policy information is forwarded in such a form as MME->UE in the aspect of a NAS message and the expression can be applied to the whole of the present invention. And, the information on the CATS-related policy can also be forwarded via WLAN rather than 3GPP access. In this case, the policy information can be forwarded in such a form as CATS policy server->P-GW->TWAN (trusted WLAN access network)->UE or CATS policy server->P-GW->ePDG->UE. As a different example, if there exists an interface between the CATS policy server and the PCRF (i.e., if the CATS policy server is connected with the PCRF), the policy information can be forwarded in such a form as CATS policy server->PCRF->P-GW->S-GW->MME->UE. And, the information on the CATS-related policy can also be forwarded via WLAN rather than 3GPP access. In this case, the policy information can be forwarded in such a form as CATS policy server->PCRF->P-GW->TWAN (trusted WLAN access network)->UE or CATS policy server->PCRF->P-GW->ePDG->UE. The P-GW may generate the CATS-related policy. In this case, the policy information can be forwarded in such a form as P-GW->S-GW->MME->UE. And, the information on the CATS-related policy can also be forwarded via WLAN rather than 3GPP access. In this case, the policy information can be forwarded in such a form as P-GW->TWAN (trusted WLAN access network)->UE or P-GW->ePDG->UE.

In the aforementioned examples, the information on the CATS-related policy can be configured in a form of a whitelist or a blacklist. The information on the CATS-related policy of the whitelist form is configured by information on an application and/or information on an application server and/or information on a communication destination in which communication is allowed or authorized. When the CATS-related policy of the whitelist form is provided, it may be able to explicitly or implicitly indicate that the policy corresponds to the whitelist. And, it may also be able to provide information on an allowance level of communication (whether communication is allowed all the time or the communication is allowed with a prescribed rate) together with the information on the application, the information on the application server, and/or the information on the communication destination in which communication is allowed. When the policy information of the whitelist form is provided, it may be able to explicitly or implicitly indicate that all of an application and/or an application server, and/or a communication destination are not allowed except the application and/or the application server, and/or the communication destination in which communication is allowed. The information on the CATS-related policy of the blacklist form is configured by information on an application and/or information on an application server and/or information on a communication destination in which communication is not allowed/authorized (blocked). When the CATS-related policy of the blacklist form is provided, it may be able to explicitly or implicitly indicate that the policy corresponds to the blacklist. And, it may also be able to provide information on a level of not allowing communication (whether communication is not allowed all the time or the communication is not allowed with a prescribed rate) together with the information on the application, the information on the application server, and/or the information on the communication destination in which communication is not allowed. When the policy information of the blacklist form is provided, it may be able to explicitly or implicitly indicate that all of an application and/or an application server, and/or a communication destination are allowed except the application and/or the application server, and/or the communication destination in which communication is not allowed.

The information on the CATS-related policy can be provided in a manner of being configured by a whitelist form only, can be provided in a manner of being configured by a blacklist form only, or can be provided in a manner of being configured by the whitelist and the blacklist. When the information on the CATS-related policy is provided, it may also be able to provide a valid period to which the policy is applied. The valid period can be respectively provided according to an application and/or an application server and/or a destination of communication. Or, the valid period can be provided by a value for the whole of the provided policy. In the foregoing description, the allowable level and the not allowable level can be provided by a plurality of information values together with a time value. For example, when the not allowable level is represented, it may use a rate_X value to indicate 20 minutes of not allowed time and a rate_Y value to indicate 20 minutes of not allowed time. The information on the application may have such a form as an application ID and/or an application name and the like. In the foregoing description, the information on the application server may have such a form as an application server IP address and/or a port number used for communicating with the application server and/or an application server name and/or an application server FQDN, and the like. In the foregoing description, the information on the communication destination may have such a form as a destination IP address of communication and/or a port number used for communication and/or a destination name of communication, and the like.

The information on the CATS-related policy can be utilized/extended using a routing policy/rule of Table 2 in the following described in TR 23.861v1.9.1.

TABLE 2

| | | Routing | | | |
|---|---|---|---|---|---|
| | Routing | access | | | |
| Routing rule | access | Type | FID | FID | |
| Name | Type | Priority | (Flow ID) | Priority | Routing Filter |
| Rule Name 1 | 3GPP | x | FID1 | a | Description of IP |
| | | | | | flows . . . |
| Rule Name 2 | 3GPP | x | FID2 | b | Description of IP |
| | | | | | flows . . . |
| Rule Name 3 | WLAN | y | FID3 | c | Description of IP |
| | | | | | flows . . . |

In order to provide information on an application, information on an application server, and/or information on communication destination in which communication is allowed, it may be able to specify the information on the application, the information on the application server, and/or the information on the communication destination in a routing filter field and it may be able to specify an allowed access type in a routing access type field. If it is necessary to allow communication for all access types or it is not necessary to designate an access type, it may define and use a new routing access type value (e.g., ALL, #, etc.). And, information on an allowable level or additional information can be provided in a manner of defining a new field or a new subfield defined in a legacy field. For an unnecessary field among legacy fields, it may not fill the field with a value or may define a value to indicate that the field is meaningless.

In order to provide information on an application, information on an application server, and/or information on communication destination in which communication is not allowed, it may be able to specify the information on the application, the information on the application server, and/or the information on the communication destination in a routing filter field. In order to indicate that communication is not allowed, it may be able to define a new field or a new subfield defined in a legacy field. In order to indicate that the communication is not allowed, it may be able to define and use a new value in a legacy field. For example, there are 3GPP and WLAN as a value of a field used for a routing access type. In this case, it may be able to define such a new value as NONE, NULL, N/A, NOTHING, etc. to indicate that the communication is not allowed. Information on a not allowable level and additional information can be provided in a manner of defining a new field or a new subfield defined in a legacy field. For an unnecessary field among legacy fields, it may not fill the field with a value or may define a value to indicate that the field is meaningless.

As mentioned in the foregoing description, when a routing policy/rule proposed for network based IP flow mobility (NBIFOM) is utilized/extensively used, a network may provide the CATS-related policy together with NBIFOM-related routing policy/rule (in a piggyback form or a merge form). On the contrary, when the CATS-related policy is provided, the network can provide the NBIFOM-related routing policy/rule together with the CATS-related policy.

Meanwhile, as a reference for determining whether to provide the CATS-related policy to the UE, at least one information selected from the group consisting of a type and a level of difficulty of a third party application associated with the CATS-related policy, location information of the UE, an access type of the UE used for communicating with the third party application associated with the CATS-related policy, subscriber information of the UE, information on whether or not the UE performs roaming, a service provider policy, and a local configuration of a network can be used individually or in combination. When a policy is generated to provide the CATS-related policy, the aforementioned informations can be used individually or in combination.

Among the informations, the type of the difficulty can be classified into a soft failure and a hard failure or can be classified into a failure, congestion, and shutdown. The level of the difficulty can be classified into a low level, a medium level, and a high level or can be represented by such a value as capability/effectiveness capable of processing communication. The network can obtain information on the type and the level of the difficulty of the third party application from a third party system/service provider/network or a different network node of a mobile communication network. Or, the network can autonomously detect the information. When the information is obtained from the external, the network can use the information as it is or use the information in a modified form.

The location information of the UE may have a form such as TAI and/or ECGI. Or, the location information of the UE may correspond to coordinate information. If the UE is connected to WLAN, the location information of the UE may correspond to such information as TWAN ID/address, ePDG ID/address, and the like. When the third party application is in a congestion situation of a high level, if a UE-1, a UE-2, . . . , a UE-48 are located at the same TA and a UE-49 and a UE-50 are located at a different TA, a network can determine to generate/provide information on the CATS-related policy not allowing communication with the third party application to the UE-1, the UE-2, . . . , the UE-48. In other word, the network can determine not to generate/provide the information on the CATS-related policy not allowing communication with the third party application to the UE-49 and the UE-50. By doing so, in order to reduce and eliminate the use of unproductive radio resource due to the traffic heading to a sever experiencing a difficulty, it may be able to reduce or mitigate radio access traffic capable of being occurred when UEs crowded at a specific area repeatedly attempt to access the third party application which is in the congestion situation of the high level.

An access type used for the UE to communicate with the third party application associated with the CATS-related policy may have such a form as 3GPP access, WLAN access, and the like. Instead of the 3GPP access, the access type may have such a subdivided form as E-UTRAN, UTRAN, GERAN, etc. When the third party application is in a congestion situation of a high level, if a UE-1, a UE-2, . . . , a UE-48 use the 3GPP access and a UE-49 and a UE-50 use the WLAN access to communicate with the application, the network can determine to generate/provide information on the CATS-related policy not allowing communication with the third party application to the UE-1, the UE-2, . . . , the UE-48. In other word, the network can determine not to generate/provide the information on the CATS-related policy not allowing communication with the third party application to the UE-49 and the UE-50. As a different example, when the third party application is in a congestion situation of a medium level, if the UE-1, the UE-2, . . . , the UE-48 use the 3GPP access and the UE-49 and the UE-50 use the WLAN access to communicate with the application, the network can generate/provide CATS-related policy for designating the WLAN access to a UE-26, a UE-27, . . . , a UE-48 as an access type for communicating with the application. The policy can be replaced with a NBIFOM routing policy/rule rather than the CATS-related policy. The aforementioned example is especially effective when the third party manages a server according to an access type in response to an identical application. For example, when the third party separately manages a server for the 3GPP access and a server for the WLAN access in response to App#1, if such a problem as congestion occurs on the server for the 3GPP access, it may generate/provide information on a CATS-related policy not allowing communication of the application to a UE accessing the application server via the 3GPP access. Or, it may be able to generate/provide CATS-related policy to a partial UE to make the UE perform communication of the application using the WLAN access.

The subscriber information of a UE can include subscriber class information of the UE in a mobile communication network, subscriber class information of the UE in a third party system/service provider/network associated with CATS-related policy, and the like.

In the foregoing description, when the information on the CATS-related policy is transmitted to the UE using a control message, it may use a procedure and/or messages for providing a routing policy/rule to the UE defined in X.1.2.3.3.1 Network-initiated IP flow mobility procedure, X.1.3.4.3 IP flow mobility, X.1.4.3.3 IP flow mobility within a PDN connection, X.1.5.3 Flows of TR 23.861v1.9.1 (Network based IP flow mobility).

FIG. 12 illustrates configurations of a UE and a network node according to an embodiment of the present invention.

Referring to FIG. 12, a UE 100 according to the present invention may include a transceiver 110, a processor 120 and a memory 130. The transceiver 110 may be configured to transmit signals, data and information to an external device and to receive signals, data and information from the external device. The UE 100 may be connected to the external device in a wired or wireless manner The processor 120 may control the overall operation of the UE 100 and may be configured to process information transmitted/received between the UE 100 and the external device. In addition, the processor 120 may be configured to perform UE operation proposed by the present invention. The memory 130 may store processed information for a predetermined time and may be replaced by a component such as a buffer (not shown).

Referring to FIG. 12, a network node 200 according to the present invention may include a transceiver 210, a processor 220 and a memory 230. The transceiver 210 may be configured to transmit signals, data and information to an external device and to receive signals, data and information from the external device. The network node 200 may be connected to the external device in a wired or wireless manner The processor 220 may control the overall operation of the network node 200 and may be configured to process information transmitted/received between the network node 200 and the external device. In addition, the processor 220 may be configured to perform network node operation proposed by the present invention. The memory 230 may store processed information for a predetermined time and may be replaced by a component such as a buffer (not shown).

The aforementioned UE 100 and network node 200 may be implemented such that the above-described various embodiments of the present invention are independently applied or two or more thereof are simultaneously applied, and description of redundant parts is omitted for clarity.

The embodiments of the present invention may be achieved by various means, for example, hardware, firmware, software, or a combination thereof.

In a hardware configuration, the embodiments of the present invention may be achieved by one or more Application Specific Integrated Circuits (ASICs), Digital Signal Processors (DSPs), Digital Signal Processing Devices (DSPDs), Programmable Logic Devices (PLDs), Field Programmable Gate Arrays (FPGAs), processors, controllers, microcontrollers, microprocessors, etc.

In a firmware or software configuration, an embodiment of the present invention may be implemented in the form of a module, a procedure, a function, etc. Software code may be stored in a memory unit and executed by a processor. The memory unit is located at the interior or exterior of the processor and may transmit and receive data to and from the processor via various known means.

Those skilled in the art will appreciate that the present invention may be carried out in other specific ways than those set forth herein without departing from the spirit and essential characteristics of the present invention. The above embodiments are therefore to be construed in all aspects as illustrative and not restrictive. The scope of the invention should be determined by the appended claims and their legal equivalents, not by the above description, and all changes coming within the meaning and equivalency range of the appended claims are intended to be embraced therein.

### INDUSTRIAL APPLICABILITY

Although the aforementioned various embodiments of the present invention are described with reference to examples applied to 3GPP LTE system, it may be applicable to various kinds of wireless communication systems as well as the 3GPP LTE system.

What is claimed is:

1. A method of controlling a third party server-related application, which is controlled by a network node in a wireless communication system, comprising the steps of:
receiving a CATS (control of applications when third party servers encounter difficulties)-related policy from a gateway; and
transmitting the CATS-related policy to a UE,
wherein the network node stores the CATS-related policy when the UE is in an idle mode.

2. The method of claim 1, wherein the CATS-related policy is transmitted in a manner of being contained in a NAS (non-access stratum) message.

3. The method of claim 2, wherein if the CATS-related policy is stored, the network node transmits the stored CATS-related policy after a TAU request message is received from the UE.

4. The method of claim 3, wherein the NAS message corresponds to a TAU accept message.

5. The method of claim 2, wherein if the CATS-related policy is stored, the network node transmits the stored CATS-related policy after a service request message is received from the UE.

6. The method of claim 5, wherein the NAS message corresponds to a DOWNLINK GENERIC NAS TRANSPORT message.

7. The method of claim 1, wherein the CATS-related policy is generated or updated when a failure occurs on the third party server.

8. The method of claim 7, wherein the CATS-related policy reduces or terminates transmission of traffic heading to the third party server.

9. The method of claim 7, wherein the CATS is generated or updated by a PCRF (policy charging resource function).

10. The method of claim 7, wherein the CATS is deleted when the PCRF recognizes restoration of the third party server.

11. The method of claim 1, wherein the network node corresponds to an MME (mobility management entity).

12. A network node controlling a third party server-related application in a wireless communication system, comprising:
a transceiver; and
a processor, the processor configured to receive a CATS (control of applications when third party servers encounter difficulties)-related policy from a gateway, the processor configured to transmit the CATS-related policy to a UE, wherein the network node stores the CATS-related policy when the UE is in an idle mode.
